(19) United States
(12) Patent Application Publication
(10) Pub. No.: US 2011/0090060 A1
(43) Pub. Date: Apr. 21, 2011

(54) Isolating RFID Reader

(76) Inventor: Milind M. Tavshikar, Belmont, MA (US)

(21) Appl. No.: 12/580,518

(22) Filed: Oct. 16, 2009

(51) Int. Cl. H04Q 5/22; G06K 7/10; H04B 10/00

(52) U.S. Cl. 340/10.3; 382/321; 398/115

(57) ABSTRACT

Systems and methods for using a multimodal handheld reader are described. The reader can be used to read non electronic labels, passive RFID tags using backscatter modulation techniques and battery based active RFID tags using a single handheld. The reader deploys a multiplexed antenna design and thereby contains a method to read a group of passive RFID tags and at the same time the reader can isolate a single passive RFID tag from amongst a group of passive RFID tags within close proximity. All such passive RFID tags use backscatter modulation techniques and are in the readers own RF zone.

### FIELD OF THE INVENTION

The invention relates generally to automated object identification and data collection, and more specifically to apparatuses and methods for automated identification and data collection using radio waves at ultra-high frequencies (UHF).

### BACKGROUND OF THE INVENTION

One example of automated identification and data collection (AIDC) technology is conventional radio-frequency identification (RFID) systems in which electronic tags transmit (or reflect) radio waves to an electronic reader. The received information is used to reference a database of known tags to identify a particular item. Another common example is a barcode (or other optical design or character set) reader that uses optical character recognition to read and recognize a unique identifier.

Often, the various systems and methods used in AIDC implementations are categorized as either short range or long range, depending on the range at which a reader can read or recognize data that resides on the tag. For example, short range systems are typically used for distances of up to a few inches. Such systems are capable of reading each individual tag distinctly in close proximity by either optically recognizing the character set in case of a barcode label, or by using the method of induction coupling between the reader and the tag in cases of radio frequency identification. Long range systems are capable of reading labels or electronic tags at a distance from a few meters to a few kilometers.

Such systems may also be categorized according to how the reader recognizes or powers the tag, as well as how the tag transmits data to the reader. For example, non-electronic readers use optical recognition techniques to read a variety of barcode labels, symbols, identification marks, and/or characters that do not have any associated electronics. Data represented by the symbols or characters on the tags or labels is typically fixed and not be altered by the reader.

Short-range passive radio frequency readers activate tags solely by providing power via the reader signal alone. In such systems, a method of inductive coupling is used so that the tags do not require an active power source. The tags harvest power from the reader to activate the electronics in the tag and the reader then reads the data from a few centimeters. Typically, one tag is read at a time. One example of a short-range system is a building access control system that uses smartcards as authentication credentials for individuals requesting access to the building. While these systems allow individual recognition of tags over short distance, they cannot be used to identify multiple tags over a long distance or about a broad area.

Long-range passive radio frequency readers also provide power to the tags but the tag data is capable of being transmitted and read from several meters away. Like short-range systems, the tags do not have a local, active source of power (e.g., a battery) however the harvested power is not used to directly communicate with the reader. Instead, a backscatter modulation process is used wherein the tag reflects the readers signal and represents data by changing the impedance of the antenna, thus modulating the reflected signal. Supply chain systems using GEN2 standard that are used in logistics, as well as other track-and-trace solutions are examples of such a system. These systems can identify multiple items from a long distance, but cannot identify a single item amongst a group of items within the field of radio effectiveness.

A passive RFID reader's primary function is to read all the tags present in its radio zone. The above-described backscatter modulation happens almost simultaneously with all tags present in the vicinity of the reader. If there are multiple tags present radio zone of the reader, there is no method by which the reader can activate only a single tag or a subset of tags. This is because all tags within the radio zone receive just enough energy to trigger the modulating circuits, thus sending all the identification numbers back to the reader as soon as enough energy is received from the reader. Thus, a reader does not have any control over which tags it can wake up.

In semi-active or battery-assisted passive systems, the tags contain a local, active power source, such as a battery. The tag uses this power source to operate the internal processing function of the tag. Typically, the tag does not operate a dedicated transmitter to communicate with the reader, but instead uses backscatter modulation wherein the tag reflects the reader signal and represents data by changing the impedance of the antenna, thus modulating the reflected signal. Such systems are deployed by toll road operators and vehicle access control applications.

Active tag systems include tags that contain an active source of power that is used for operating internal processing functions of the tag and operating a dedicated transceiver to communicate with the reader. Examples of such systems are cellular phones, PDAs, GPS devices, amongst others.

The technologies mentioned above are suitable for either a single-read type of usage or mass-read type of usage in a mutually exclusive way.

### SUMMARY OF THE INVENTION

Various aspects of the invention provide apparatuses, methods and systems for improving wireless scanning capabilities. More specifically, the techniques and systems described herein facilitate the identification and data collection from individual RFID tags within a large population of tags disbursed about a broad area, and at a long distance. Such a system includes multiple Radio Frequency (RF) technologies on a single architectural platform, thus eliminating the need to operate parallel infrastructures.

In one aspect the disclosure is directed to a reader system that comprises of a RF module, a Controller Module, A antenna and a application for automatic identification and data collection. The RF module directly communicates with the tags based on commands sent to it by the controller module. The application module requests certain kind of information from the controller module i.e., the controller module receives an input from the application and based on the needs of the application. In response, the controller module modifies or sets the characteristics of the RF module and the antenna module.

In another aspect, the characteristics of the reader is such that it can detect the presence of multiple Passive RFID tags present in its field of radiation and at the same time it is able to isolate a single tag within the group.

In one embodiment the reader is able to singularly identify a particular tag of interest and eliminate other tags present in adjacent areas within a close proximity of the tag of interest but within the readers field of radiation.

In another embodiment the reader is able to read barcodes and passive RFID tags using its RF module and at the same time transmit the acquired data to the backend system using its controller module over UHF frequencies achieving a long transmit distance and without the need to deploy expensive WiFi or GPRS technologies. Optical module of the reader can scan barcodes and RF module can read tags simultaneously. For example, when one has a pallet of boxes with each box having a UHF RFID tags and a barcodes on each box. If one of the boxes needs to be removed from the pallet due to a visual damage and all others need to be counted, our reader can scan the barcode of that particular damaged box on the pallet using the optical module and count all boxes on the pallet using the RF module in a single scan.

### BRIEF DESCRIPTION OF THE DRAWINGS

The following figures depict certain illustrative embodiments of the invention which like reference numerals refer to like elements. These depicted embodiments are to be understood as illustrative of the invention and not limiting in any way.

FIG. 1 illustrates one embodiment of an environment in which an automatic identification and data collection system operates.

FIG. 2 schematically depicts a reader for use in an automatic identification and data collection system in accordance with various embodiments of the invention.

FIG. 3 illustrates using the reader of FIG. 2 to identify specific tags in a tag population in accordance with various embodiments of the invention.

FIG. 4 schematically depicts a multiplex antenna structure in accordance with various embodiments of the invention.

FIG. 5 is a cross-section of the bottom of the reader of FIG. 2 in accordance with various embodiments of the invention.

FIG. 6 is a cross-section of the top of the reader of FIG. 2 in accordance with various embodiments of the invention.

FIG. 7 is a diagram of the reader of FIG. 2 in accordance with various embodiments of the invention.

FIG. 8 is a system flowchart illustrating the processes performed by the reader of FIG. 2 in accordance with various embodiments of the invention.

### DETAILED DESCRIPTION

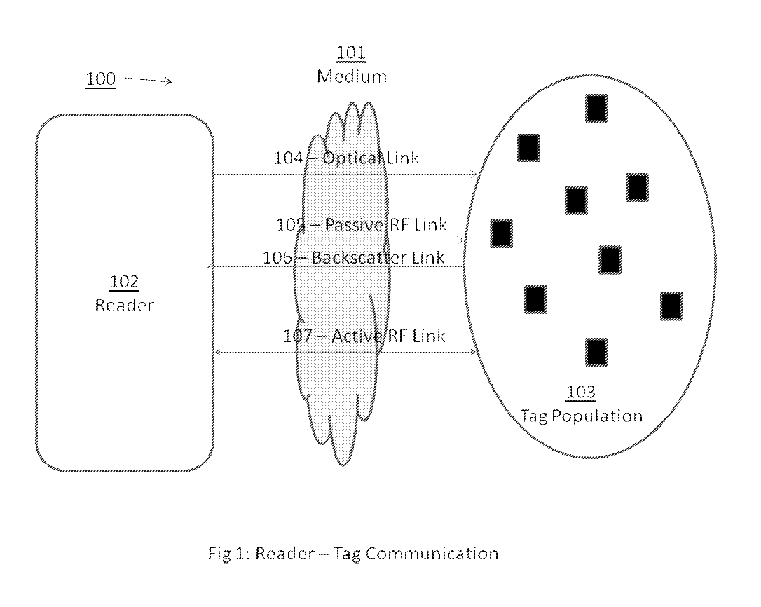

FIG. 1 is an illustrative example of an environment 100 in which an automatic identification and data collection system may operate. The system includes a reader 102 and a population of tags 103 that communicate with one another through one or more mediums 101 and using communication links 104,105,106 and 107. While described herein as wireless links using radio-frequency signals, these links are illustrative only and may include other links such as wired, cellular, optical and others. The medium can be free space or some other medium capable of supporting communication between the reader 102 and the tag population 103. In one embodiment the medium may also carry reflected radio waves and communicate over a variety of frequency ranges.

The reader 102 transmits data (and, in some cases, power) to the tag population 103 using an optical carrier wave. The beam of light may be in a visible or invisible spectrum, and the data is typically modulated onto the optical carrier wave. Some tags (e.g., optically-powered semi-active tags or battery-assisted active tags) receive the optical transmission and demodulate the data and may either transmit information back to the reader or, in some cases remain silent. In such cases, the tags include a microcontroller that demodulates the signals received from the reader. In instances in which the tag population includes a non-electronic label, an optical module of the reader 102 scans symbols and/or characters on the label and converts them into data for further processing.

In some embodiments, the reader 102 transmits radio frequency signals via a passive RF link 105 to the tag population 103. In other cases, the electronic tags respond to the reader and modulate the reader signal to send back unique identification numbers via backscatter link 106. In other cases, the reader 102 listens to the signals being sent by a set of active tags present in the population of the tags 103 using an active RF link 107. In such cases, the reader sends a wakeup signal to the active tags in the tag population 103, and the tags respond to the call with a unique identification code.

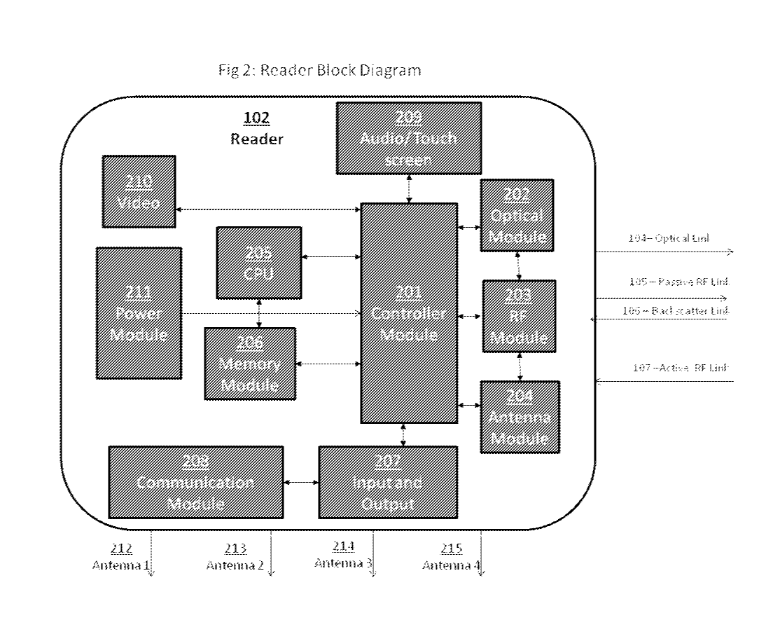

With reference to FIG. 2, the reader includes a controller module 201 that manages communication, interoperability and power distribution among the various components of the device, including on board peripherals. Each component and peripheral may require different power management techniques and the controller module 201 includes circuitry to distribute power as necessary to various modules such as a barcode reader module, a passive RFID reader module, and an active RFID module.

The reader 102 also may include an optical module 202 for communicating with photovoltaic-activated tags and non-electronic tags within the tag population 103. Non-electronic labels are recognized using conventional optical character recognition techniques. An RF module 203 communicates with the entire tag population 103 using a radio frequency channel. The RF module 203 operates in a reader-talk-first mode as the reader continuously radiates radio waves directed at the tag population 103. Using backscattering, tags within RF field receiving sufficient energy may then modulate the reader signal and reflect it back to the reader along with the identification number of the tag.

In such cases, all tags receiving the RF signal modulate the carrier wave simultaneously and the reader communicates with the tag using a phase-reversal amplitude shift keying modulation. An envelope detector may be used to determine the number of tags responding within a cycle. Tags may also use a slotted aloha algorithm or pulse interval encoding to communicate with the reader one at a time, thus reducing collisions as more tags are read over time.

In one embodiment of the invention, the RF module 203 communicates with a single tag amongst the population 103 using a radio frequency channel. The RF module 203 operates in a reader-talk-first mode and the reader continuously radiates radio waves directed at the tag it wishes to energize, or in the direction of interest. Operating in this fashion, the reader 102 uses a low-power dipole antenna that radiates energy only in the direction of the tag of interest. As such, the tag of interest is the only tag that communicates with and identified by the reader 102. All other directions in which radio signals may emit out of the dipole antenna are suppressed using an RF non-conducting medium. The antenna field of the reader forms a horizontal plane similar to a disk with maximum energy at the point directly in front of the antenna. The radio field of the antenna diminishes significantly and is almost not existent within a few centimeter of the point of maximum power. As a result, the tag directly in front of the reader receives sufficient energy to activate a backscatter circuit and thus communicate with the reader 102.

In another embodiment, the RF module 203 communicates with active tags in the tag population 103 by operating in a tag-talk-first mode. The RF module 203 listens continuously as the tags broadcast indentifying information. The active tags typically transmit data at a predefined interval and any read/write operations are performed once communications are established between the reader 102 and the tags.

An antenna module 204 includes a combination of antennas and rubber-duck antennas. The antenna module 204 attenuates the antenna signals and adjusts gains per the need of the RF module 203. Antenna module can control multiple antennae based on instructions provided by the controller module 201.

A CPU 205 communicates with the controller module 201. The CPU 205 may be any type of processor core, dedicated processor, dedicated fine state machine (FSM), field programmable gate array, or application specific gate logic. The CPU 205 executes stored instructions retrieved from a memory module 206, for example. These instructions, when executed, cause the processor to co-operate with the other modules of the reader 102 and allow smooth functioning of the controller module in particular. The memory module 206 may include a volatile memory, or, in some embodiments, one or more storage mediums such as ROM, PROM, EPROM, RAM, SRAM, FRAM and MRAM. In another embodiment, the memory module 206 may also include a permanent storage area where application-specific data and executable programs are stored.

An input and output block 207 provides serial and parallel buses needed for data communication between the on-board modules and peripherals. The input/output block 207 may support devices such as a multimedia card, secure digital and other secure digital I/O communications protocols. Data-transfer rates up to 19.5 Mbps for MMC and 1-bit SD/SDIO, and up to 78 Mbps for 4-bit SD/SDIO transfers are provided. Components of the block 207 allow the reader to access memory on peripheral devices. Application programs can access such memory blocks and use information on the same for processing logic.

A communication module 208 processes signals from the antennas on the reader. In one embodiment the communication module 208 provides 802.11 b/g capabilities, Wi2Wi W2SW0001 controller module, Up to 54 Mbps, 2.45 GHz band, On-board antenna and connector for external antenna. Components of the module 208 are used for backend communication of the reader with external systems. Real time data access is made by the reader to read or write data as necessary by the application programs.

In some implementations, the reader 102 may include a touch screen and audio module 209 that includes transducers and speakers that provide audio and touch input functionality to the reader 102. An on-board microphone and speaker connectors, as well as an external audio jack may be included. A video module 210 may include a graphics controller for presenting application information, menus and other data using multi-bit color having a resolution of up to 800×600. The video module also drives a camera interface for use with digital and/or analog cameras of varying resolutions.

A power supply module 211 provides power to the reader and its components. In one embodiment, the power supply 210 is a DC power supply and includes a DC-DC conversion circuitry for efficient power distribution. In other embodiments, the power supply may be an AC power supply where power is regulated outside of the reader module 102. In operation the power module 211 provides the means to operate all components of reader 102.

Antennas 212, 213, 214 and 215 communicate with the tag population and other backend systems. In one embodiment, the antenna 212 includes a patch antenna and the antennas 213, 214 and 215 are waveguide slot antennas. In some implementations, the reader 102 includes two or more different types of antennas. When used in combination, the different antennas are multiplexed via the antenna module 204 which in turn is controlled by the RF module 203 and the controller module 201.

Attenuation levels of the antennas may be adjusted by changing independently-adjustable gain levels using circuits on the controlling module. When properly adjusted, the antennas form a beam with adjustable transmitter and receiver antenna gains.

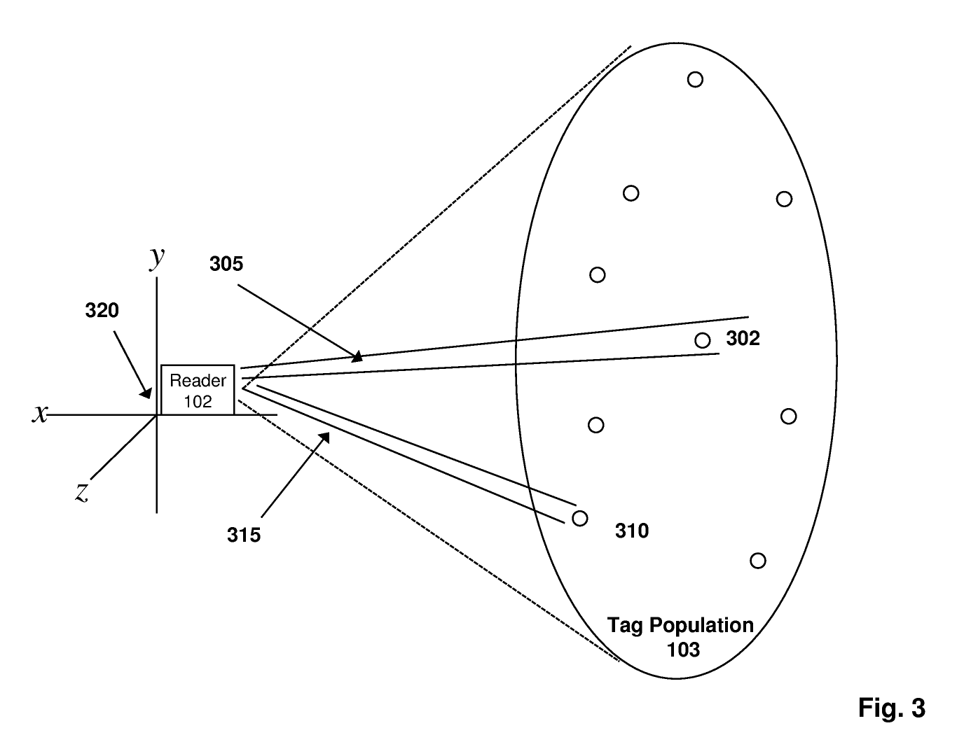

Referring to FIG. 3, the backscatter modulation used to identify specific tags in the tag population 103. More specifically, the modulation is controlled by shielding all backscatter signals using the antenna radiating the signals itself. For example, RF energy from the reader 102 is directed towards the tag population 103, including passive tag 310 and passive tag 302. and only backscatter signals from tag 302 are received by the reader 102. In one embodiment, Antenna module 204 on reader 102 shields all other backscatter signals except the one coming from tag 302 by deploying a non radio conducting medium in between tag and reader signals. In some cases, other tags within the signal zone may be ignored by implementing the multiplexing functionality of the RF module 203. Once tag 302 is read, the user (or a mechanical device) may then sweep the reader about the targeted area in order to detect other tags, such as tag 310. As the signal zone 315 envelops tag 310, it is activated and recognized by the reader 102.

The reader in this mode uses a low power dipole antenna that radiates energy only in the direction of the tag of interest. All other directions in which radio signals may emit out of the dipole antenna are suppressed using a non-conducting RF medium. The antenna field of the reader forms a horizontal plane similar to a disk with maximum energy at the point exactly in front of the antenna. The radio field of the antenna diminishes significantly (approaching zero) within a few centimeter of the point of maximum power. Using this design, the tag directly in front of the reader gets sufficient energy from the reader for the tag's backscatter circuit to activate and thus communicate with the reader.

In some implementations, the reader 102 my be placed according to a known coordinate system 320. Using the coordinates, the reader 102 may determine its location in space (using, for example, GPS coordinates) or relative to other known objects (buildings, walls, warehouse fixtures, etc.). With a known reader location, orientation (e.g., direction of use) and distance to/from a particular tag, the exact location of a tag may be calculated.

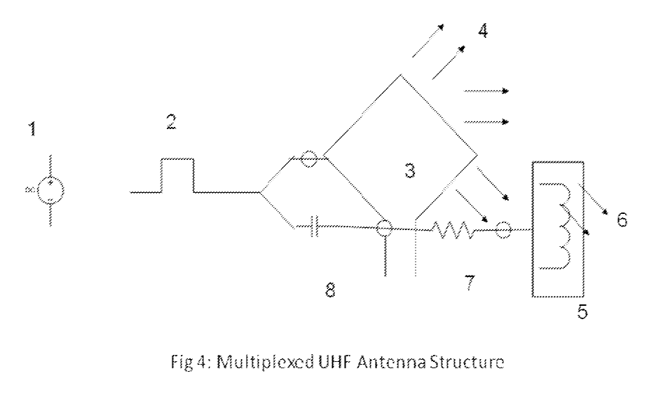

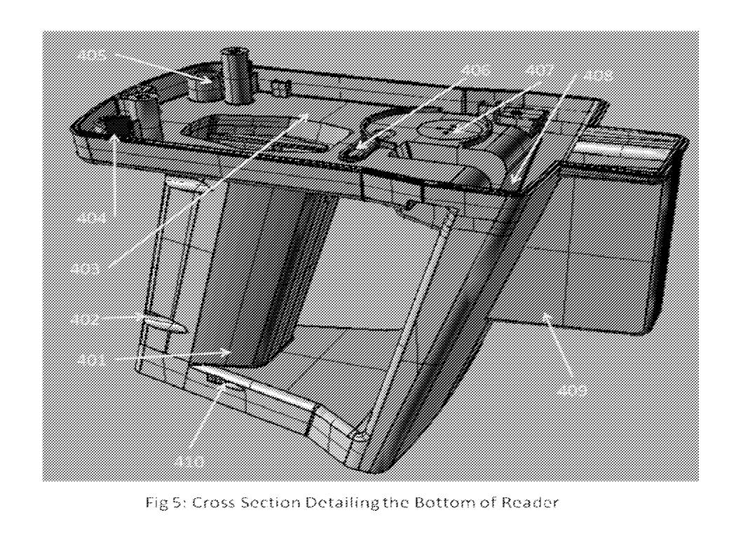

FIG. 4 illustrates one embodiment of a multiplexed antenna structure that may be used to implement the above-described functionality. The antenna includes a combination of a loop antennas and a dipole antennas. Both antennas are controlled by a single input provided by the controller. The antenna arrangement allows loop antennas to send radio energy in the medium whereby tags within range can operate using a backscatter transmission mechanism. For a single read a digital pulse is sent by the controller board to the dipole antenna that blocks all but reads only the tag under consideration. The loop antenna which is implemented using a patch mechanism creates a radio field in the shape of a inflated balloon. All passive tags in the radio range are activated and transmit back their identification numbers to the patch antenna. The Dipole antenna produces a radio field with horizontal circular plane. Only the tag directly in front of the field receives sufficient energy to send back its signal to the dipole antenna. The reader module can distinguish between all backscatter coming in from the patch and isolate those from the single read coming in from the dipole. Both the loop antenna and dipole can be used independently as well in parallel to each other.

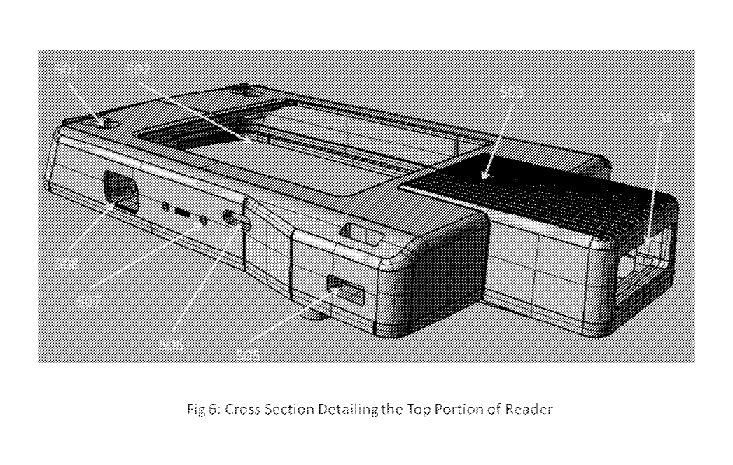

FIGS. 5-7 illustrate the reader in greater detail. The reader includes battery 401 that supplies power to the reader, which is held in place by fixtures and a battery cover 402, which may be used as a handle for the reader. A controller compartment 403 accepts the controller module. Antenna compartment 404 holds comprises one or more antenna sockets for accepting antennas used to communicate with other 802.11 devices or GSM/GPRS systems. In some implementations, a GPS-specific antenna 405 may be included to facilitate communication with external GPS devices. All antennas positions are interchangeable and configurable. Interface 406 connects the power module to the controller module. The reader may also include a high volume, low power speaker 407. Antenna housings 408 and 409 are used to accept antennas for reading passive RFID tags. The physical positioning of the antennas are such that they do not detune one another. A recharging coupling 410 may be included to recharge the batteries as needed.

With reference to FIG. 6, a recessed nut-bolt combination 501 secures the top portion and bottom portion of the reader 102. Display and touch panel unit 502 (which may include anti-glare capabilities) is used to receive and display information as the reader is in use. Housings 503 and 504 contain the optical module that communicates with optical and non-electronic labels. Belt holder 505 may be used to strap the reader to a user's clothing belt. LED indicator window 506 provides visual indication of the operating status of reader 102. Reset pin button 507 and USB port 508 provide additional communication capabilities.

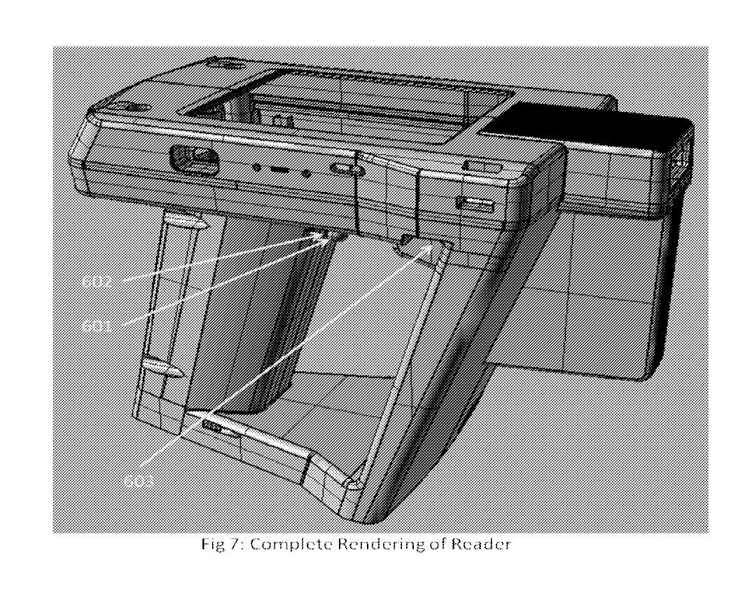

With reference to FIG. 7, trigger 610 is used to initiate scanning of labels or individual tags. On/Off switch 602 powers up the device.

In one embodiment, the reader includes embedded software stored in memory that implements the methods described above. The software includes instructions for alternating between reading a group of passive tags in its radio zone and reading a single tag from the tag population. When operating in single tag mode, the dipole antenna is activated. The dipole antenna reads the tags directly in front of the point where the horizontal plane of the dipole antenna overlaps with the antenna of the tag being read. By determining which signal is being received at the dipole antenna versus the loop antenna and can thus differentiate multiple reads from the single reads under consideration.

In another embodiment the reader has a method to read a mix of passive tags and active tags in its own radio zone and transmit data about the identification numbers of these tags to a backend system using its own RF signal. Different antennas are used to communicate with active and passive tags.

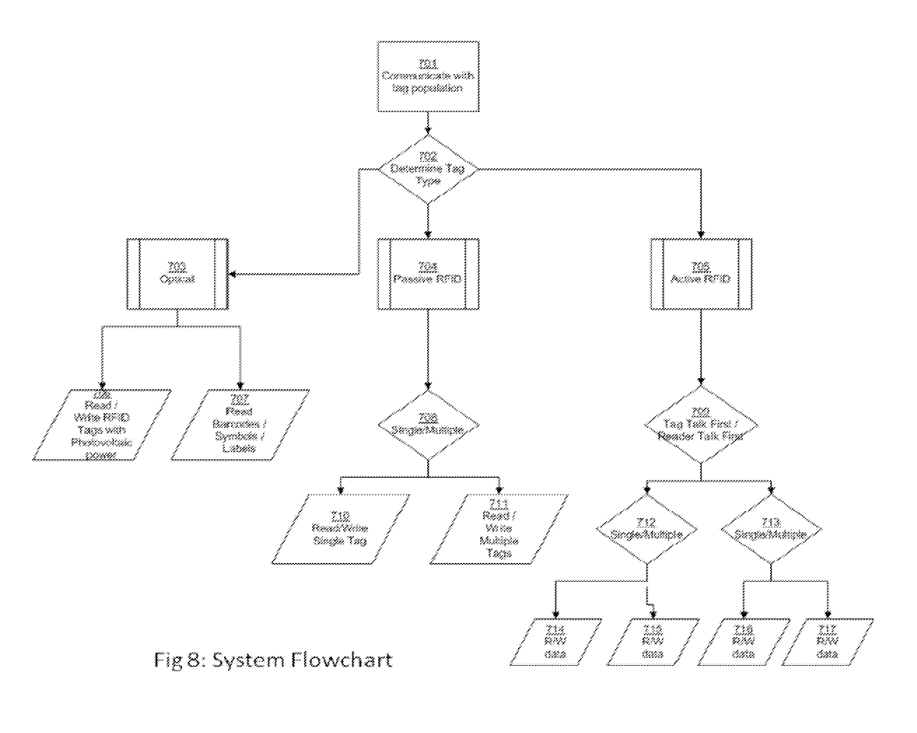

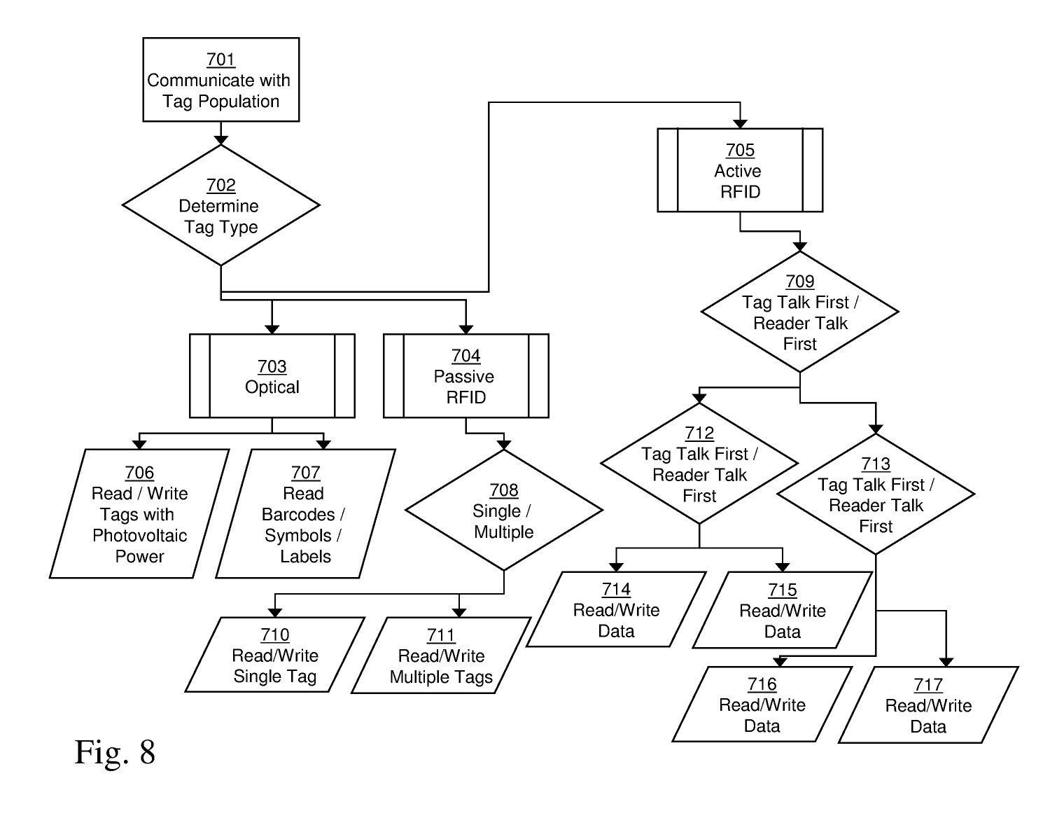

FIG. 8 is a flowchart of the system components of the reader application. The system initiates communication with the population of tags (STEP 701). The type of tag/communication is determined (STEP 702) and the respective read processes are initiated. For example, when an optical RFID tag is to be read an optical read process 703 is initiated. Alternatively, or in parallel, a passive read process 704 and/or an active read process 705 are initiated using passive RFID backscatter signal. This allows a single barcode to be read along with all passive RFID tags within a tag population.

For optical tags, a tag read/write process 706 may be used to communicate with optical RFID tags, and a conventional barcode/symbol read process 707 may be used for identifying barcode tags. For the active and passive RFID processes, either a single tag process (710 or 712) or a multiple tag read process (711 or 713) may be used, depending on the desired application.

What is claimed is:

1. An apparatus for interrogating a population of wireless identification tags, the apparatus comprising:
a radio frequency module for broadcasting radio frequency signals to and receiving backscatter modulated radio-frequency signals from the tags; and
an antenna assembly comprising at least one dipole antenna and at least one loop antenna configured to shield radio energy from all tags in the population of tags except a particular tag of interest.

2. The apparatus of claim 1 further comprising an optical reader module for identifying barcodes.

3. The apparatus of claim 1 further comprising a controller module configured to multiplex and demux optical signals and radio frequency signals simultaneously.

4. The apparatus of claim 1 further comprising a global positioning system (GPS) module for determining a physical location of the apparatus.

5. The apparatus of claim 1 wherein the antenna operates within a ultra-high frequency band.

6. The apparatus of claim 2 wherein the controller module is further configured to alternate between a single-tag read mode and a multi-tag read mode.

7. The apparatus of claim 1 wherein the population of identification tags comprise one or more of barcode tags, active RFID tags, and passive RFID tags.

8. The apparatus of claim 1 further comprising a communication module for collecting information received from the identification tags and transmitting the collected information to one or more external systems.

9. The apparatus of claim 2 wherein the controller module is further configured to adjust attenuation levels and power levels of the antenna by altering the respective gain levels associated with antenna.
